(19) United States
(12) Patent Application Publication
(10) Pub. No.: US 2007/0183498 A1
(43) Pub. Date: Aug. 9, 2007

(54) Apparatus and method for transition point detection, recording apparatus and record playback apparatus

(75) Inventor: Shoji Nakashima, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/648,543

(22) Filed: Jan. 3, 2007

(30) Foreign Application Priority Data
Feb. 6, 2006 (JP) 2006-028041

(51) Int. Cl. H04N 7/12

(52) U.S. Cl. 375/240.12; 375/240.26

(57) ABSTRACT

A digital recording apparatus of the present invention comprises an encoder for generating an encoded stream by encoding an input signal comprised of a digital video and digital audio signals, and a system controller for receiving encode information of the encoder and generating a management file of the encoded stream. The system controller detects a transition point of a video or an audio signal in the input signal according to a change of compressed data amount for the encoder to generate the encoded stream and generates the management file added with information of the transition point.

### BACKGROUND OF THE INVENTION

1. Field of the Invention

The present invention relates to an apparatus and method for transition point detection for detecting a transition point including an image start point that is included in an input signal formed by a digital video and/or digital audio signal, and a recording apparatus and a record playback apparatus including a transition point detection function.

2. Description of Related Art

With an increase of storage capacity in a mass storage device including hard disk recorder, and DVD (Digital Versatile Disk), it is becoming easier to handle a large amount of video signals. Thus users are able to dub a program once recorded and video shot by a digital video camera to a mass storage device to edit, and also to save the edited video to DVD etc to save it. In this case, automatically detecting a scene change and commercials in a program facilitates user's editing process.

FIG. 6 is a block diagram showing a conventional digital image recording apparatus. A digital image recording apparatus 110 includes a signal input unit 111 for outputting a digital video and digital audio signals, an encoder 112 for compressing images in a specified format including MPEG (Moving Picture Expert Group), a buffer 113 for temporarily storing an encoded stream, a system controller 114 for controlling each block, and a recording unit 140.

The users supply a video or television video shot by a digital camera etc from a playback apparatus 130 to the signal input unit 111, and then save it to the recording unit 140 temporarily. The users are then able to create an edited video comprising only desired videos using the saved video, and also to edit for example to delete an unnecessary portion.

A recording apparatus in which no conversion is performed to commercial videos is disclosed in Japanese Unexamined Patent Application Publication No. 2000-69414 as against to a film video that is converted to a television video (telecine conversion) In this recording apparatus, a period having no field match, in which two field videos including a frame in between them, is detected as a commercial. Further, a dynamic image scene information management apparatus is disclosed in Japanese Unexamined Patent Application Publication No. 2001-326901. The dynamic image scene information management apparatus calculates a distance between frames. If the distance between frames is larger than a specified threshold, it determines that there is a scene change, and accumulates/manages first frame of each scene. By using these apparatuses, it is possible to save videos with commercials removed and create edited videos with thumbnails for each scene change.

For the playback apparatus 130 of FIG. 6 to supply a video to the recording unit 140 to record it, generally the system controller 114 inputs an image from the playback apparatus 130 to the signal input unit 111 at the same time when directing to start recording and also controlling the encoder 112 to compress video and audio data from the signal input unit. Then the system controller 114 sends the compressed data to the recording unit 140 to record.

However, it has now been discovered that as the digital recording apparatus controls the signal input unit 111 and the encoder 112 by the system controller 114 at the same time, an actual data transition point will not be considered due to signal delay (system delay) of each unit. Then unnecessary video including blue back and white noise or no signal portion having no video signals (videos other than actual video signals are hereinafter referred to as unnecessary videos) is recorded.

Specifically, in case a video from a video tape is recorded to the recording unit 140 including DVD recorder, the unnecessary videos containing no video exist in beginning of the video tape. Recording this video to the recording unit 140 may record the unnecessary video such as white noise. Generally a recording apparatus has a function to list titles (shows) in a DVD or a hard disk by small images (thumbnails) automatically selected. However if the white noise is selected and displayed as a thumbnail, users are unable to identify contents of the titles. To display thumbnails of the actual video signal portions to identify the titles, the users are able to delete the unnecessary video signal using editing function after being recorded, it requires a task to find breaks of the unnecessary videos and the actual video, which is extremely troublesome.

### SUMMARY OF THE INVENTION

According to an aspect of the present invention, there is provided a transition point detection apparatus that includes an encoder and a transition point detector. The encoder generates an encoded stream by encoding an input signal comprised of a digital video and/or digital audio signal. The transition point detector detects a transition point of video and/or audio signal in the input signal according to a change of compressed data amount for the encoder to generate the encoded stream.

According to another aspect of the present invention, there is provided a recording apparatus that comprises an encoder encoding an input signal comprised of a digital video and/or digital audio signal to generate an encoded stream, and a system controller generating a management file of the encoded stream according to encode information of the encoder. The system controller detects a transition point of a video and/or an audio signal in the input signal according to a change of compressed data amount for the encoder to generate the encoded stream and generates the management file added with information of the transition point.

The present invention enables to generate the management file added with the transition point information that can be used to detect the transition point of the video or audio signal in the input signal according to a change of compressed data.

According to another aspect of the present invention, there is provided a record playback apparatus that comprises an encoder encoding an input signal comprised of a digital video signal and/or digital audio signal, a system controller generating a management file of the encoded stream according to encode information of the encoder, a recording unit recording the encoded stream and the management file, and a playback unit decoding the encoded stream recorded to the recording unit to play it. The system controller detects a transition point of a video and/or an audio signal in the input signal according to a change of compressed data for the encoder to generate the encoded stream and generates the management file added with information of the transition point, and the playback unit plays the encoded stream according to the transition point information added to the management file.

In the present invention, the encoded stream is played according to the management file added with the transition information of the transition point detected according to the change of the compressed data by the playback unit. In this case, it is possible not to display streams before the transition point and to display an image of the transition point as a thumbnail.

Thus the apparatus and method for transition point detection of the present invention enables to detect the transition point of the recorded stream data. Furthermore, the apparatus and method for transition point detection enables to record the management file added with the transition point information together with the stream data, facilitating the editing process of the recorded stream data.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing a digital image recording apparatus according to a first embodiment of the present invention;

FIG. 2A is a view explaining a first transition point detection method by a transition point detector according to the first embodiment of the present invention;

FIG. 2B is a view explaining a second transition point detection method by a transition point detector according to the first embodiment of the present invention;

FIG. 3 is a flowchart showing an operation of the digital image recording apparatus according to the first embodiment of the present invention;

FIG. 4 is a flowchart showing an operation of a system controller according to the first embodiment of the present invention;

FIG. 5 is a flowchart showing an operation of a system controller according to a second embodiment of the present invention; and

FIG. 6 is a block diagram showing a digital image recording apparatus according to a conventional technique.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

In this embodiment, the present invention is applied to a recording apparatus having a transition point detection function that detects a video start point indicating a break between the unnecessary video portion including the blue back and white noise or the no signal portion (the unnecessary video portion) having no video signal and the actual video start point as a transition point.

### First Embodiment

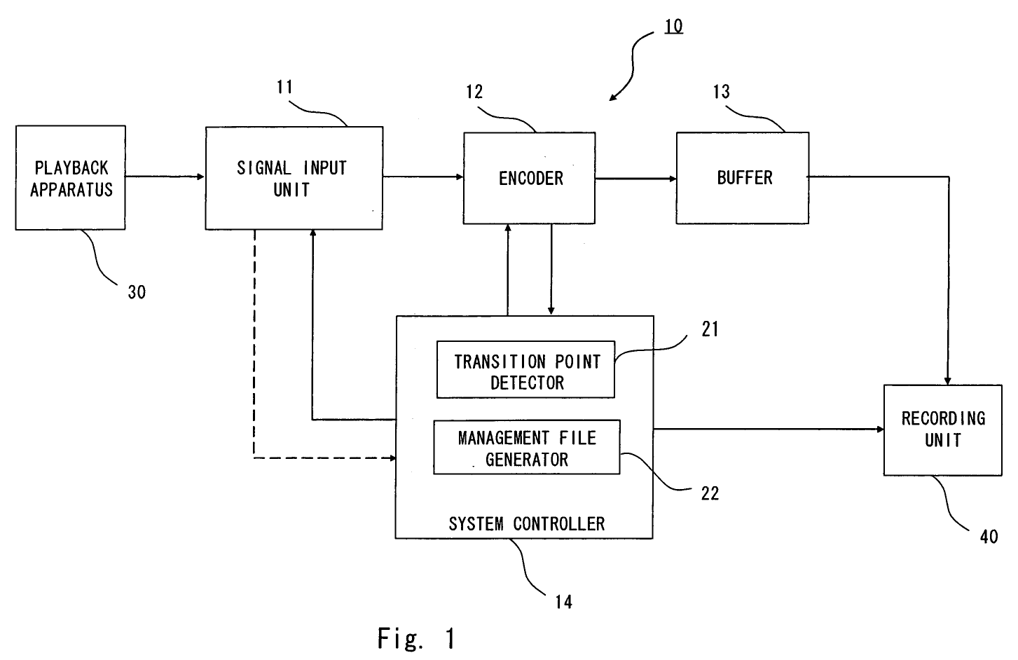

FIG. 1 is a block diagram showing a digital image recording apparatus according to a first embodiment of the present invention. As shown in FIG. 1, a digital image recording apparatus 10 of this embodiment includes a signal input unit 11 for outputting a digital video and digital audio signals, an encoder 12 for compressing images in a specified format including MPEG, a buffer 13 for temporarily storing an encoded stream, a system controller 14 for controlling each block, and a recording unit 40.

The digital image recording apparatus 10 is supplied with a digital or analog signal shot by a video camera, for example, or television video recorded on a video tape from the playback apparatus 30. The digital image recording apparatus 10 then encodes and supplies it to the recording unit 40 having a hard disk or an optical disk etc that are not shown. The recording unit 40 may either be for storing data to a removable recording medium including DVD or for storing data to a built-in recording media including hard disk drive.

The signal input unit 11 is configured by a video decoder and/or DV (Digital Video:IEC61834) codec and converts analog video and audio signals being input into digital video and audio signals, decodes DV data and converts it to uncompressed digital video and digital audio signals, and supplies the converted digital video and digital audio signals to the encoder 12. The signal input unit 11 detects an input signal, specifically detects a no signal period to a video start, for example, and notifies it to the system controller 14.

The encoder 12 compresses the digital video and digital audio signals in a specified format including MPEG2. At this time the encoder 12 supplies information for encoding (hereinafter referred to as encode information) to the system controller 14. The encoded data (hereinafter referred to as an encoded stream) is supplied to the recording unit 40 via the buffer 13.

The system controller 14 once supplied with the digital or analog video signal from the playback apparatus 30 controls the signal input unit 11 and the encoder 12 to start encoding. The system controller 14 includes a transition point detector 21 and a management file generator 22. The management file generator 22 in the system controller 14 generates an index file as a management file that includes information listing sequence headers that are at the beginning of each GOP (group of picture) and recording information including information that is referenced image data according to the encode information. The index file is recorded together with a file of the encoded stream encoded by the encoder 12 to the recording unit 40.

The system controller 14 of this embodiment detects a transition point of video or audio signal in the encoded information according to a change of an amount of compressed data by the transition point detector 21. In this embodiment, the transition point detector 21 detects a video start point as the transition point of the video or audio signal in the encoded information according to a change of an amount of bit rate. Then the management file generator 22 adds a chapter having transition point information to the index file according to a result of the transition point detection by the transition point detector 21. Adding the chapter to the video start point as the transition point facilitates an edition process of the encoded stream recorded to the recording unit 40.

The video signals supplied from the playback apparatus 30 may include no signal including white noise before the video start point and the unnecessary video portion including blue back. If the video signals including these are encoded and recorded to the recording unit 40, this unnecessary video portion before the video start point is recorded as well. An example in case the playback apparatus 30 of the user displays the no signal portion as the blue back is described hereinafter in detail. For example if a user records video for a plurality of time using a digital video camera and records the plurality of recorded videos to the recording unit 40, the blue back is included before each of the recorded video start point. If an apparatus for playing and editing the stream recorded by the recording unit 40 includes a function for displaying a first image by a thumbnail and identifying a content of its title, the blue back is included in a break of each recorded video. Thus thumbnail images of the plurality of recorded videos are displayed as the blue back. Accordingly the user is not able to identify the contents of the recorded videos by the thumbnails, disabling to recognize what the video data indicates. To edit such stream in an editing apparatus by the user, the user needs to delete the blue back portion (the unnecessary video portion) one by one, thereby complicating the editing process after the recording process.

Further, if the input signal information of the signal input unit 11 is sent to the system controller 14 to prevent from recording the no signal portion included in the beginning of the video, accurate position of the video start point cannot be detected due to signal delay of each processors including input signal unit 11 and the encoder 12. As the delay of the encoder 12 differs depending on video to be processed, it is difficult for the system controller 14 to determine the accurate video start point to control to start recording without feedback information from the encoder 12 to the system controller 14.

The system controller 14 of this embodiment receives information at an encoding process from the encoder 12. Then the information of the video start point detected by the transition point detector 21 is added to the index file normally generated. This enables the user to edit recorded data by this chapter, and also facilitates the editing process including a deletion of the unnecessary video portion without looking for a break between the unnecessary video portion including blue back and the actual video start point.

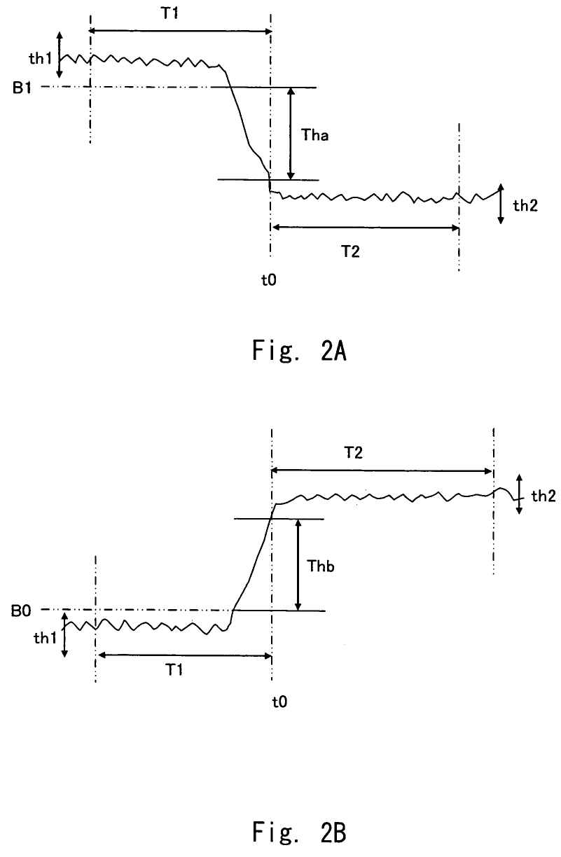

FIGS. 2A and 2B show views explaining respectively a first and a second transition point detection methods by the transition point detector 21. The transition point detector 21 of this embodiment detects the video start point using the method described hereinafter. In the first method as shown in FIG. 2A, a point that the bit rate decreases by more than a threshold Tha from a signal larger than a specified value B1 is detected as the video start point. For example for the white noise, the bit rate becomes larger than the actual video portion, thus it is evaluated by the specified value B1. Specifically, signals larger than the specified value B1 can be determined as noise signals such as white noise. The bit rate decreases at the point the actual video starts. Detecting this change by the threshold Tha enables to detect the video start point.

In the second method as shown in FIG. 2B, a point that the bit rate increases by more than a threshold Thb from a signal smaller than a specified value B0 is detected as the video start point. For example for the blue back, the bit rate becomes smaller than the actual video portion, thus it is evaluated by a specified value B0. Specifically, signals smaller than the specified value B0 can be determined as noise signals such as the unnecessary video signal. Then at the point the actual video starts, the bit rate increases. Detecting this change by the threshold Thb enables to detect the video start point.

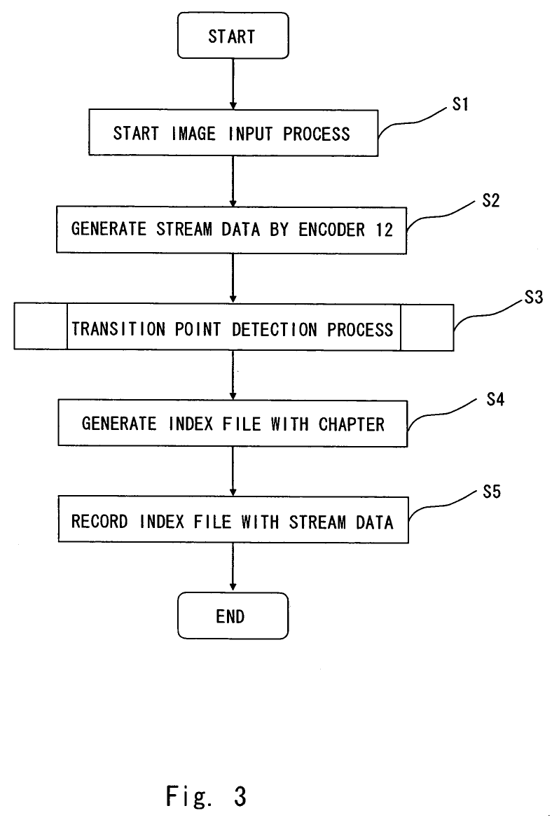

FIG. 3 is a flowchart showing an operation of the digital image recording apparatus of this embodiment. Firstly the system controller 14 controls the signal input unit 11 and the encoder 12 to start an image input process (step S1). Then the encoder 12 encodes digital image data decoded and digitalized by the signal input unit 11 to generate stream data (step S2). At this time the system controller 14 receives information at the encoding process including bit rate from the encoder 12. In this embodiment, both the bit rate of the video and audio signals can be received. However the transition point may be detected according only to the change of the bit rate amount of the video signals, or it may be configured to let a user to appropriately select these functions.

Further the transition point detector 21 detects the transition point, which is the video start point, according to the change of the bit rate (step S3). Once the transition point detector 21 detects the transition point, the management file generator 22 generates the index file added with the chapter at the position (step S4). Further, the recording unit 40 records the stream data supplied via the buffer 13 and the index file generated by the management file generator 22 to a recording media including a disk (step S5).

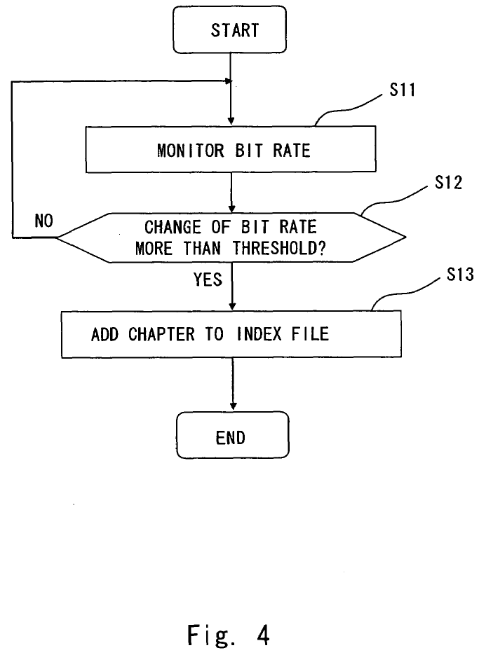

Processes from the transition point detection to index file generation in steps S3 and S4 are described hereinafter in detail. FIG. 4 is a flowchart showing an operation of the system controller 14. The transition point detector 21 monitors the bit rate supplied from the encoder 12. Then if the change of the bit rate is larger than a threshold (step S2:Yes), this point is detected as the video start point. Specifically as described in the foregoing, a decrease of the bit rate is more than the threshold Tha or an increase of the bit rate is more than the threshold Thb is detected. The management file generator 22 adds the chapter to the index file at a respective position. At this time, as described later in detail, the transition point may be determined with consideration over other information including the notification from the signal input unit.

With the above operations, the index file added with the chapter as the video start point information along with the stream data are recorded to the recording unit 40. In case there exists the unnecessary video in the beginning of a video or a break between videos, this enables to easily delete and edit the unnecessary video portion or to display a thumbnail of the video start point according to the chapter. That is, the user no longer needs to look for the video start point and is able to edit easily by using the chapter in the index file.

### Second Embodiment

A second embodiment of the present invention is described hereinafter in detail. This embodiment is another example of a transition point detection by a system controller. That is, as described in the foregoing, the transition point detector 21 may detect the transition point only by the increase or decrease of the bit rate, however by referring to fluctuation of the bit rate before and after the transition point and the information of whether the video signal from the signal input unit 11 exist or not, it is possible to further improve an accuracy of the transition detection. A configuration of the digital recording apparatus is identical to that of the first embodiment shown in FIG. 1.

Returning to FIGS. 2A and 2B, after detecting the point t0 in which there is a decrease more than the threshold Tha from the bit rate larger than the specified value B1 or the point t0 in which there is an increase more than the threshold Thb from the bit rate smaller than the specified value B0, the change of the bit rate in a specified period T1 before the detection point t0 is evaluated whether it is within a specified threshold th1. If it is evaluated to be within the threshold th1, the point is determined to be the video start point.

Further, after detecting the point t0 in which there is a decrease more than the threshold Tha from the bit rate larger than the specified value B1 or the point t0 in which there is an increase more than the threshold Thb from the bit rate smaller than the specified value B0, the change of the bit rate in a specified period T2 after the detection point t0 is evaluated whether it is within a specified threshold th2. If it is evaluated to be within the threshold t2, the point is determined to be the video start point.

Further, the signal input unit 11 may detect the no signal period (where no video or audio signal exists) and after detecting the video start, the signal input unit 11 may notify it to the system controller 14. The system controller 14 can add the chapter to the index file according to a result of the detection by the transition point detector 21 and the notification from the signal input unit 11.

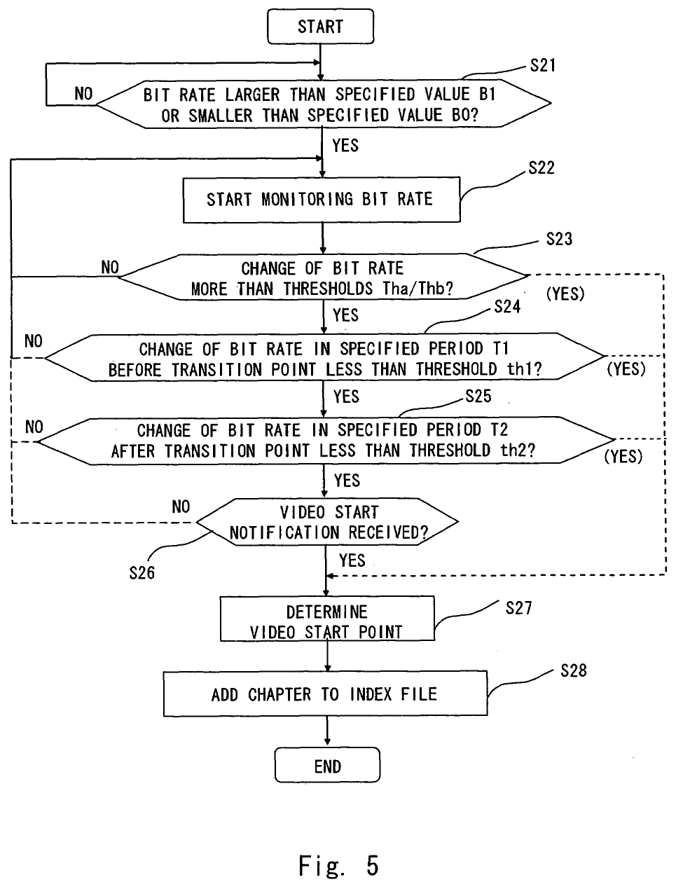

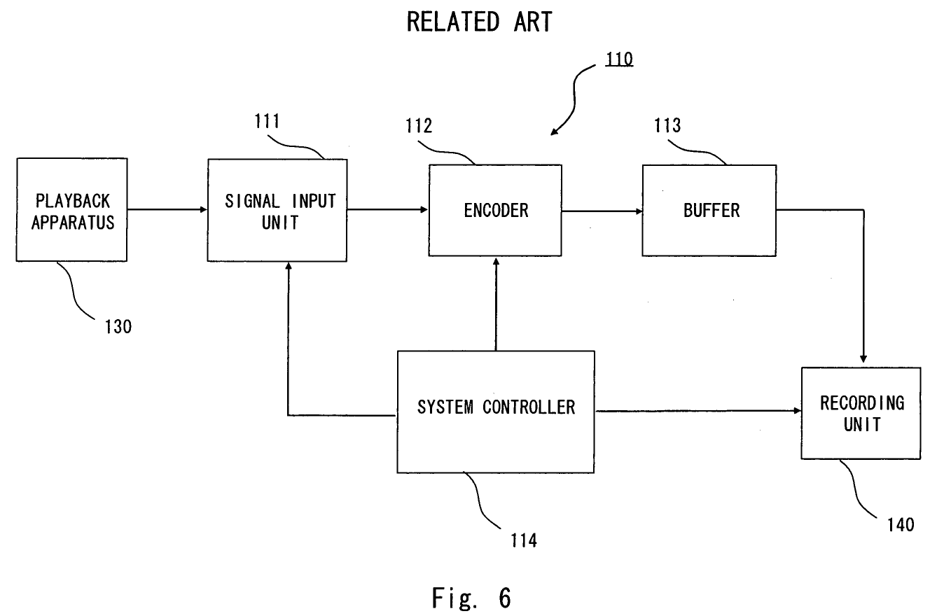

FIG. 5 is a flowchart showing one example of the above operation, corresponding to the steps S3 and S4 in FIG. 3. As shown in FIG. 5, the transition point detector 21 evaluates whether the bit rate is more than the specified value B1 or less than the specified value B0 (step 21). If the bit rate is more than the specified value B1 or less than the specified value B0, it starts monitoring the bit rate (step S22). Further, if the bit rate decreases by more than the threshold Tha from the specified value B1 or increases by more than the threshold Thb from the specified value B0, the point t0 is evaluated to be highly likely to be the video start point and then the process moves to the next step. At this time the following steps S24 to S26 may not be executed and the process may move forward to the step S27 to determine the video start point. On the other hand if the bit rate is more than the specified value B1 or less than the specified value B0, it is evaluated as a normal video portion (step S21:No) This evaluation is repeated until the bit rate becomes more than F the specified value B1 or less than the specified value B0.

In this example, the process moves to the next step S24. In the step S24, the change of the bit rate in the specified period T1 before the detection point t0 is evaluated whether it is less than the threshold th1. For example for the blue back, the white noise, and the no signal period, the fluctuation of the bit rate is considered to be due only to the noise, and making use of that fact that an amount of the fluctuation in the no signal period is small. If the change of the bit rate in the specified period T1 is less than th1, the following steps S25 to S26 may not be executed but the process may move forward to the step S27 to determine the detection point t0 as the video start point. In this example, the process moves forward to the step S25.

In the step S25, the fluctuation of the bit rate in a specified period T2 after the detection point t0 is evaluated whether it is less than the threshold th2. This is because that once the actual video is started, the fluctuation of the bit rate is expected to be within a normal video range. If the fluctuation of the bit rate in the specified period T2 is less than th2, following step S26 may not be executed but the process may move forward to step S27 to determine the detection point t0 as the video start point. In this example, the process moves to the step S26.

In the step S26, it is evaluated whether the video start notification from the signal input unit 11 is received or not. As the notification will not be sent in case the no signal period does not exist before starting the actual video, the transition point may be detected only by the change of the bit rate. The specified values B1 and B0, the thresholds Tha, Thb, th1, and th2, and the specified periods T1 and T2 are considered to differ depending on the video signal being input and specification of the playback apparatus etc. However the values may be specified by previously calculating values that can accommodate general images. Further, these parameters may be modified externally as necessary.

After determining the detection point t0 as the video start point according to the above information (step S27), the management file generator 22 generates the index file added with the chapter at the position corresponding to the detection point t0. In the first and the second embodiments, the video start point is detected by the change of the bit rates of both audio and video data. However only the change of the bit rate of the audio data or video data may be detected to determine the video start point.

In this embodiment, the point in which the change of the bit rate is assumed to be the video start point. Then by looking at the change of the bit rate before and after the video start point, the video start point can be detected more accurately.

The present invention is not limited to the above embodiment and it may be modified and changed without departing from the scope and spirit of the invention. For example in this embodiment, the video start point is detected, however a video end point can be detected using the identical method. As an example, when recording a video by a video camera, an unnecessary video could be included between recorded videos accidentally or intentionally. In such case, adding the chapter for the video end point facilitates an editing process. To detect the video end point, if the bit rate changes much more than a range of the bit rate for normal video signals, for example the bit rate increases more than a specified threshold value or decreases more than a threshold value, the point can be detected as the video end point considering that the actual video portion is ended. Otherwise as with the above embodiment, the video end point may be detected according to the information of the fluctuation of the bit rate in a specified period before and/or after the transition point along with the change of the bit rate.

In this embodiment, the system controller 14 only generates the index file added with the chapter for the transition point, and the stream data is recorded as it is. However the stream data may be edited. Specifically, after detecting the video start and end points by the system controller 14, the video from the video start point to the video end point are recorded and each unit may be controlled to delete the unnecessary video portions included in the input signals. Furthermore, it may be configured in a way that the user is able to choose externally whether to generate the index file added with the chapter for the video start point or to record the stream data removed with the unnecessary video portion.

In the above embodiments, the recording apparatus is explained however it may be a record playback apparatus. In such case, the record playback apparatus further includes in addition to the components of FIG. 1, a decoder for decoding the encoded stream, a video encoder for encoding a decoded digital video signal, a DA converter for converting a digital signal to an analog signal, and a display unit for displaying videos.

The system controller 14 controls these playing processes. In this case, the encoded stream of this embodiment is recorded together with the index file added with the chapter at the video start position. Thus the system controller is able to display an image at the position indicated by the chapter in the encoded stream in a thumbnail to the display unit. This leads an image at the video start position to be the thumbnail displayed, thereby preventing the unnecessary video signal portion to be displayed in the thumbnail. Further, with the thumbnails displaying normal video portions enables the users to easily grasp contents of the videos, thereby supporting processes including playback and edition.

Further, the record playback apparatus may include an editing function. In such case, as the index file recorded to the recording unit of this embodiment includes the chapter at the video start point, the unnecessary video portions before the video start point can be removed using the editing function.

It is apparent that the present invention is not limited to the above embodiment and it may be modified and changed without departing from the scope and spirit of the invention.

What is claimed is:

1. A transition point detection apparatus comprising:
an encoder that generates an encoded stream by encoding an input signal comprised of a digital video and/or digital audio signal; and
a transition point detector that detects a transition point of video and/or audio signal in the input signal according to a change of compressed data amount for the encoder to generate the encoded stream.

2. The transition point detection apparatus according to claim 1, wherein the transition point detector detects a first point where the compressed data amount decreases from a signal larger than a first specified value by more than a first threshold or a second point where the compressed data amount increases from a signal smaller than a second specified value by more than a second threshold as the transition point.

3. The transition point detection apparatus according to claim 1, wherein the transition point detector detects a first point where the compressed data amount decreases from a signal larger than a first specified value by more than a first threshold or a second point where the compressed data amount increases from a signal smaller than a second specified value by more than a second threshold, and
if a change of compressed data amount in a specified period before the first point is within a specified threshold, the first point is detected as the transition point and if a change of compressed data amount in a specified period before the second point is within a specified threshold, the second point is detected as the transition point.

4. The transition point detection apparatus according to claim 1, wherein the transition point detector detects a first point where the compressed data amount decreases from a signal larger than a first specified value by more than a first threshold or a second point where the compressed data amount increases from a signal smaller than a second specified value by more than a second threshold, and
if a change of compressed data amount in a specified period before the first point and/or if the change of compressed data amount in a specified period after the first point is within a specified threshold, the first point is detected as the transition point and if a change of compressed data amount in a specified period before the second point and/or if the change of compressed data amount in a specified period after the second point is within a specified threshold, the second point is detected as the transition point.

5. The transition point apparatus according to claim 1, wherein the system controller detects the transition point according to a change of compressed data amount for the digital video signal and/or a change of compressed data amount for the digital audio signal.

6. A method for detecting a transition point comprising:
generating an encoded stream by encoding a digital video and digital audio signals; and
detecting a transition point of a video and an audio signals in the digital video and digital audio signals according to a change of compressed data amount for the encoder to generate the encoded stream.

7. A recording apparatus comprising:
an encoder that encodes an input signal comprised of a digital video and/or digital audio signal to generate an encoded stream; and
a system controller that detects a transition point of a video and/or an audio signal in the input signal according to a change of compressed data amount for the encoder to generate the encoded stream and generates a management file added with information of the transition point.

8. The recording apparatus according to claim 7, wherein the system controller detects a first point where the compressed data amount decreases from a signal larger than a first specified value by more than a first threshold or a second point where the compressed data amount increases from a signal smaller than a second specified value by more than a second threshold as the transition point.

9. The recording apparatus according to claim 7, wherein the system controller detects a first point where the compressed data amount decreases from a signal larger than a first specified value by more than a first threshold or a second point where the compressed data amount increases from a signal smaller than a second specified value by more than a second threshold, and
if a change of compressed data amount in a specified period before the first point, the first point is detected as the transition point and if a change of compressed data amount in a specified period before the second point, the second point is detected as the transition point.

10. The recording apparatus according to claim 7, wherein the system controller detects a first point where the compressed data amount decreases from a signal larger than the first specified value by more than a first threshold or a second point where the compressed data amount increases from a signal smaller than a second specified value by more than a second threshold, and
if a change of compressed data amount in a specified period before the first point and/or if a change of compressed data amount in a specified period after the first point is within a specified threshold, the first point is detected as the transition point and if a change of compressed data amount in a specified period before the second point and/or if a change of compressed data amount in a specified period after the second point is within a specified threshold, the second point is detected as the transition point.

11. The recording apparatus according to claim 7, wherein the system controller detects the transition point according to a change of compressed data amount for the digital video signal and/or a change of compressed data amount for the digital audio signal.

12. The recording apparatus according to claim 7, further comprising a signal supply unit that supplies the input signal to the encoder,
wherein the signal supply unit notifies a start timing of the digital image signal included in the input signal to the system controller, and
the system controller detects the transition point according to the start timing and the change of compressed data amount.

13. The recording apparatus according to claim 7, wherein the signal supply unit converts an analog image signal to a digital image signal.

14. The recording apparatus according to claim 7, wherein the signal supply unit decodes a compressed digital image signal to an uncompressed digital image signal.

15. The recording apparatus according to claim 7, wherein the management file added with the transition point information is an index file added with a chapter.

16. A record playback apparatus comprising:
an encoder that encodes an input signal comprised of a digital video signal and/or digital audio signal;
a system controller that detects a transition point of a video and/or an audio signal in the input signal according to a change of compressed data for the encoder to generate the encoded stream and generates a management file added with information of the transition point;
a recording unit that records the encoded stream and the management file; and
a playback unit that decodes the encoded stream recorded to the recording unit and plays it according to the transition point information added to the management file.

17. The record playback apparatus according to claim 16, wherein the playback unit displays a thumbnail of the encoded stream according to the transition information added to the management file if the playback unit decodes and plays the encoded stream.

18. The record playback apparatus according to claim 16, wherein the playback unit includes a function to edit the encoded stream according to the transition point information added to the management file and deletes streams in the encoded stream before the transition point.
